(19) United States
(12) Patent Application Publication
(10) Pub. No.: US 2008/0126211 A1
(43) Pub. Date: May 29, 2008

(54) Method and apparatus for a mutual fund "gift" card

(76) Inventor: Ann Kaufhold, Gulph Mills, PA (US)

Correspondence Address: FOX ROTHSCHILD LLP, 100 PARK AVENUE, SUITE 1500, NEW YORK, NY, 10017, US

(21) Appl. No.: 11/520,098

(22) Filed: Sep. 13, 2006

(51) Int. Cl. G06Q 40/00

(52) U.S. Cl. 705/16; 705/37

(57) ABSTRACT

A mutual fund “gift” card method and apparatus is presented. An established financial network between a mutual fund “gift” card issuer, a broker and a retail financial institution allows for the gifting of a monetary sum to a recipient in which the gift giver retains some control over how the gift proceeds are utilized. Control is established through the mutual fund “gift” card being associated with a particular retail financial institution or a financial product of the financial institution. The card issuer issues the gift card in a selected denomination to the gift giver and the recipient, upon receipt of the card, redeems the card with the financial institution. Monetary funds are then transferred accordingly.

### FIELD OF THE INVENTION

The present invention relates generally to a method and apparatus for establishing a mutual fund “gift” card, and more particularly, to a method and apparatus for directing gifted money from a recipient to an investment vehicle consisting of a money market mutual fund or the like.

### BACKGROUND OF THE INVENTION

Gifting of money has reached unprecedented historical levels and has become a major factor in the redistribution of wealth worldwide. Indeed, in the United States alone according to statistics complied by the Internal Revenue Service, as recently as 2004, the latest year for which such figures are “official,” gifts (including donations to charitable institutions) reached over $34 trillion dollars. Many of these gifts are given with tax considerations in mind and as estate planning and control mechanisms.

However, at the level of smaller individual family gift giving, for example, wedding gifts, gifts for children, etc., “cash” gift giving via, for example, personal checks can never be controlled by the gift giver if the gift giver would like the gift to be “used wisely”. As is well understood, once the gift is given it is up to the recipient to decide how such gift is utilized. This factor perhaps has been an inhibition to family member or close friend “cash” gift giving as the giver of the gift would perhaps like to see the money utilized in a certain fashion.

Currently there are few methods by which a “cash” gift giver can direct a recipient to use the gift “wisely.” What methods do exist require the gift giver to disclose personal information regarding either the giver or the recipient. For instance, if an individual desires that any monetary gift to be given be utilized solely for educational purposes, the gift giver will normally be required to open what is referred to as a 529 Plan account. In doing so, the gift giver must disclose his or her own personal information including at the very least name, address and social security number. The same is true with regard to the requirement of disclosing the recipient's personal information, if for instance an individual desires to purchase U.S. Treasury Bonds as a gift for another as an investment vehicle to ensure that the gift earns a guaranteed interest over time. The gift giver is required to disclose at the very least the recipient's name and social security number. For many persons, given the fear of theft of such personal information and its consequences (e.g., identity theft), disclosing such personal information is not acceptable and thus their monetary gift giving may be curtailed.

Additionally, current “card” products on the market or in general use do not function as a mutual fund “gift” card would for the purposes of transferring wealth from one individual to another with a control component. For instance, banking cards (e.g., ATM cards, credit cards, debit cards, etc.) all allow ready access to cash, but rarely allow for the card giver to maintain some type of control to ensure the money is utilized “wisely.” Indeed, as is well understood, credit cards and debit cards are used when making purchases as an alternative to cash. Credit cards can be particularly poor “gifts” if the recipient does not understand the ramifications of uncontrolled spending and/or if the gift giver is required to guarantee card payments. Likewise, funds can be withdrawn directly from the gift giver's checking or savings account at a bank or credit union if the recipient makes uncontrolled purchases with a debit card.

As can be seen, such obstacles have further perhaps placed a damper on monetary gift giving.

### SUMMARY OF THE INVENTION

Accordingly, the present invention addresses these problems to give the gift giver some control over how the monetary gift is utilized, encourages further perpetuation of the gift giving process, and, for gifts given by check, eliminates the multiple step process needed to cash a check and redirect the funds to an investment vehicle. In addition, the mutual fund “gift” cards of the present invention have no affiliation with any investment products.

Various investment alternatives are established for a monetary gift giver, and the eventual recipient of the monetary gift, through a “gift” card issuer. Either the card issuer, or a broker with whom the issuer has established accounts, chooses a retail financial service company or an investment vehicle offered by various retail financial services companies. Accordingly, the issuer can offer investment in money-market mutual funds, stock funds, bond funds, etc. for the gift giver to choose from. In this manner then the issuer is acting as a liaison between the gift giver and the financial industry.

After the gift giver selects a denomination amount for the monetary gift and pays the card value to the distributor, a mutual fund “gift” card is issued by the card issuer to the gift giver. Issuance of the card may be at a Point-Of-Sale (POS) location, such as at a brokerage house or a retail goods store, or may be electronic via a web-site. Having purchased the mutual fund “gift” card, the gift giver may now transfer, or gift, the card to a recipient.

The recipient of the mutual fund “gift” card can redeem the card with the issuer, broker or the retail financial company. Such redemption takes the form of selection of an investment vehicle and the funds equal to the value of the card are then paid into the investment vehicle.

The present invention, including its features and advantages, will become more apparent from the following detailed description with reference to the accompanying drawings.

### BRIEF DESCRIPTION OF THE DRAWINGS

FIG. 1 is an illustration of a flow chart diagram detailing the steps utilized in establishing and transferring of monetary funds of the mutual fund “gift” card, according to an embodiment of the present invention.

FIG. 2 is an illustration of a block diagram of the participating financial institutions for the establishment and transferring of monetary funds of the mutual fund “gift” card, according to an embodiment of the present invention.

FIG. 3 is an illustration of a flow chart of the purchase and redemption of the mutual fund “gift” card, according to an embodiment of the present invention.

### DETAILED DESCRIPTION

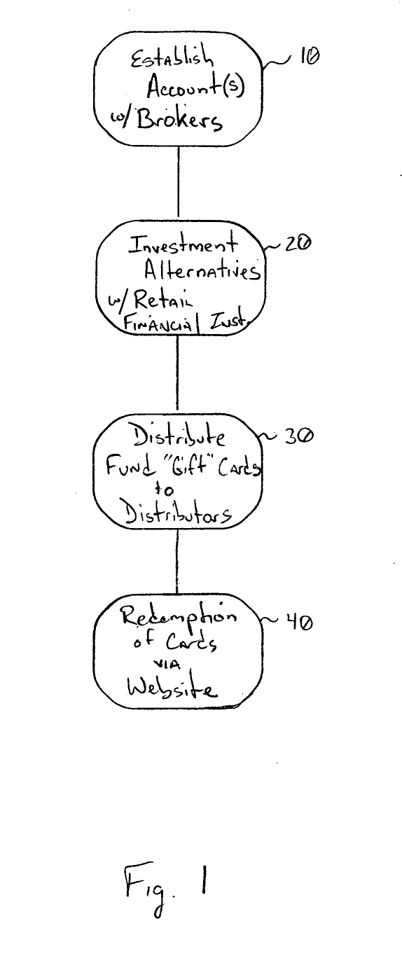

FIGS. 1 through 3 show a method and apparatus by which a mutual fund “gift” card establishment and distribution system can be put in place to allow for individuals to purchase the cards and make monetary gifts to select individuals. It is to be understood, of course, that the “Fund Gift Card” can be a physical card, not unlike the current gift cards found at most POS kiosks in many of today's retail institutions, or a digital card existing in an account somewhere.

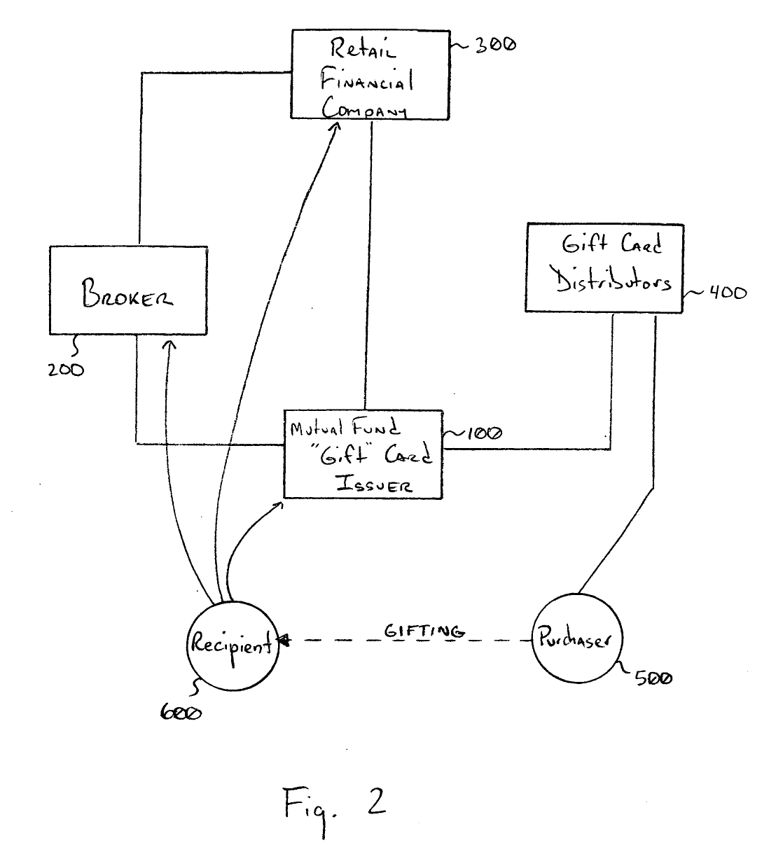

Referring now specifically to FIGS. 1 and 2, in step 10 a mutual fund “gift” card issuer 100 creates a “gift” card system by establishing an account with a financial broker/dealer 200. The broker will eventually act as a distributor of the “gift” card funds. Brokers, for example, may be Merrill Lynch, the Bank of America, or Prudential. In step 20, the broker/dealer 200 and/or the card issuer 100 establish investment vehicles, products and/or alternatives for the gift card recipients 600 with select retail financial companies 300 offering money market mutual funds. It is to be understood that for purposes of the present invention, the money market mutual-funds are defined as mutual funds that invest in short-term debt instruments such as treasury bills, municipal notes, certificates of deposit, etc. The retail financial companies, for example, may be Vanguard, Fidelity, etc. Naturally, then, it is to be further understood that other types of financial instruments and/or securities may also be invested in (e.g., stock funds, bond funds, REITS, etc.).

Having established the financial umbrella and communication networks under which the “gift” card system will operate, in step 30 the mutual fund “gift” card issuer 100 establishes a distribution network for the gift cards by contacting various gift card distributors 400. The gift card distributors 400 will be responsible for direct sales of the “gift” cards to purchasers 500. Preferably, such distributors 400 may be consumer good retail outlet stores and/or web-sites, for example, companies such as Barnes & Nobel, Amazon.COM, Starbucks, etc. It is to be understood, of course, that the Issuer 100, Broker/Dealer 200 and/or Financial Company 300 may also act as a distributor 400.

Accordingly, based on the above, the following relationships are established between the mutual fund “gift” card issuer 100 (i.e., the Mutual Fund Gift Card Company): 1. a relationship between the broker-dealer(s) to “cash” the card's value, and place the card's dollar amount into a mutual fund money market account for its beginning starting point of the investment process; 2. a relationship between the mutual fund family(ies) to invest the monies of the card's value in order to make the actual “investment” that the gift giver had intended; and 3. a relationship with the gift card distributors 400 (i.e., the retail establishments) that will sell the Mutual Fund Gift Cards.

The denomination of the “gift” card can be varied, allowing for determination by the purchaser 500 of the card as to the value of the card and thus the gift. Additionally, certain cards having select investments may have minimum purchase levels (e.g., a minimum purchase of $25) or, alternatively, incentives for higher investment amounts. The “gift” cards may also be printed such that the denomination (i.e., amount) of the gift is printed on the face of the card, or may be more discrete, not showing the denomination, but rather having some symbol or artwork that corresponds to the amounts.

Such “gift” card system allows the Purchaser 500 to retain more control over how and where the recipient must ultimately must redeem the card's value in a money market fund (cash). For example, if Purchaser 500 wants to make a monetary gift to a nephew or nice graduating from college and the purchaser believes that the Vanguard money market mutual funds are the best investment for the nephew/niece, then the Purchaser 500 will purchase a “gift” card to one of Vanguard's money market mutual funds. Such control will act to encourage the gift card purchaser to perpetuate the investment process, encouraging savings for young adults and children, and provides a more accessible way to add to fund investments.

The “gift” cards now being available for purchase by the purchaser 500, in step 40 a redemption method via a web-site is established. A Recipient 600, having received the “gift” card from the Purchaser 500, logs-on to a web site (not shown) at either the Card Issuer 100, Broker 200, or Financial Company 300. The web site, as explained in further detail below, will allow the recipient to direct the investing process by choosing from the available money-market funds and to perhaps redirect the gift card proceeds to various stock/bond funds. This allows the recipient 600 of the card to have the opportunity to place the proceeds into a money market (cash) mutual fund in a current fund family he/she currently owns, or open a new account if no account has ever been established. It is to be understood that while the recipient of the gift card can self direct the process through the card website, alternatively, the recipient can be “hand-held” through the assistance of a broker.

Thus, it is to be understood that the Recipient of the card will be able to redeem the card in physical or virtual locations, or send the card directly in to a fund company of a currently owned fund. For instance, if the Recipient 600 desires to physically redeem the card, the Recipient may redeem the card in any wire-house or bank broker/dealer that he chooses or already has an established relationship with. This option will allow the added benefit of having a broker guide him through the investment selection process of what mutual fund might be right for him (if he is a first time investor). Alternatively, if the Recipient 600 desires to virtually redeem the card, the Recipient may utilize the online step-by step tutorial at the website. The tutorial guides the card holder through the process of redeeming the card on-line.

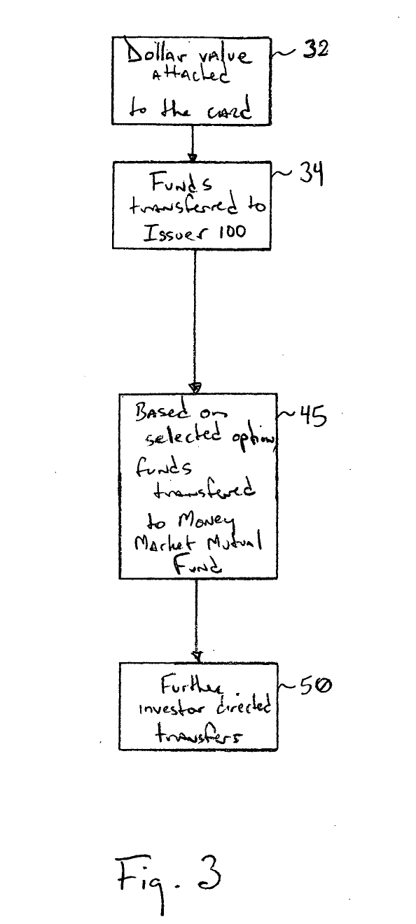

Referring now to FIG. 3, the “gift” card purchase and redemption methodology for the flow of the monetary funds is shown. The purchaser 500 (i.e., the gift buyer) pays the Gift Card Distributor 400, for instance, Target $200.00 for a mutual fund gift card. Target swipes the card, and in step 32 then, the dollar value amount is assigned to the gift card. Such value may already be assigned to the card (i.e., pre-valued), or, through a tracking means, such as a tracking number on the back of the card, will have the dollar value attached to the card via the tracking number. This allows Mutual Fund Gift Card Co. to know this card with this amount is out there and will be redeemed anytime soon. In step 34 the funds need to be collected from Target timely, as per retail agreement with Target due to the nature of the investment process (clearing).

The Recipient 600 now owns a $200.00 mutual fund gift card. As mentioned above with regard to redemption, the tracking number will also allow the recipient to log onto website. Recipient will be given options as to whether they would like to: a) add to current mutual fund already owned; b) Open new fund through on-line tutorial (where options will be much more limited); or c) Open new fund through the guidance of a broker. They will be given various broker-dealers to choose from (e.g., bank, wire-house, and independent). The advantage of a broker is more guidance.

Regardless of which option selected, in step 45 the funds are then deposited in a MONEY MARKET MUTUAL FUND. At this point then the mutual fund gift card is considered to have been “cashed”. Such transfer of the funds is the necessity of the “back office” of the broker/dealer. The tracking of the card will show the gift card has been redeemed. If it was a $200 card, $200 will go into a money market mutual fund. The recipient will have decided which money market mutual fund based on which mutual fund family he would like to invest with.

For example: if the recipient would like to invest with Fidelity Funds, then the $200 will go into a Fidelity money market mutual fund. This enables tracking of the investing for accounting purposes; enabling Fidelity to collect further “loads” as they typically do on their funds. By way of another example, if the Recipient goes to the web site and cashes in the gift card for a Oppenheimer fund with a 4.5% load ($9.00), the moment the card was redeemed a check to Oppenheimer for the value of the card will be issued.

It is to be understood that should a recipient want to split the $200; the same concept—$100 into Fund Family A, $100 into Fund Family B, etc., can be implemented. Thus in step 50, the Recipient 600 may make further transfers/investments of the mutual fund gift card proceeds. There will be separate accounts set up between The Mutual Fund Gift Card Co. and each Mutual Fund Co., as well as each broker/dealer.

Mutual Fund Gift Card Co. will have a transaction as well as dealer agreement with both the broker/dealers and mutual fund families to account for their profitability. This would only benefit the consumers of the cards as cost competitions could occur.

Accordingly, such methodology solves the technical problem that if an investor already has a fund set up, they no longer have to cash a recipient's check, wait for clearance, rewrite a new check and redeposit into the fund. Alternatively, the fund card can be simply be directly deposited into the recipient's fund.

Thus, as can be seen from the above disclosure, the present invention clearly and conclusively allows the gift giver some control over how the gift is to be utilized, encourages further giving, and removes obstacles the average person may have to investing in financial securities thus making the concept of mutual fund buying less daunting to mainstream America.

In the foregoing description, the method and apparatus of the present invention have been described with reference to a specific example. It is to be understood and expected that variations in the principles of the method and apparatus herein disclosed may be made by one skilled in the art and it is intended that such modifications, changes, and substitutions are to be included within the scope of the present invention as set forth in the appended claims. The specification and the drawings are accordingly to be regarded in an illustrative rather than in a restrictive sense.

What is claimed is:

1. A method for a mutual fund “gift” card, the method comprising the steps of:
associating an investment vehicle with a “gift” card;
assigning a monetary denomination to the “gift” card; and
transferring monetary funds corresponding to the monetary denomination of the “gift” card from a point-of-sale to the investment vehicle,
wherein such transfer of monetary funds occurs upon redemption of the “gift” card by a recipient.

2. The method according to claim 1, wherein the investment vehicle is at least one of a money market mutual fund, a stock mutual fund, a bond mutual fund, or an equity or income investment product.

3. The method according to claim 1, further comprising the step of:
distributing the “gift” card to a point-of-sale.

4. The method according to claim 1, further comprising the step of:
placing the monetary funds collected at the point-of-sale in exchange for the “gift” card into a cash account.

5. The method according to claim 1, further comprising the step of:
allowing for redemption of the “gift” card.

6. The method according to claim 1, wherein the recipient of the “gift” card is an owner of an account in the investment vehicle into which the monetary funds corresponding to the monetary denomination of the “gift” card are deposited.

7. The method according to claim 1, wherein a monetary gift giver may purchase the “gift” card at at least one of a broker, a retail financial institution, a point-of-sale kiosk, and a web site.

8. The method according to claim 1, wherein the monetary denomination of the “gift” card is determined prior to the point-of-sale or at the time of purchase.

9. A method of directing monetary funds into a mutual fund after gifting, the method comprising-the steps of:
associating a “gift” card with an investment product offered by a financial institution;
making the “gift” card available for purchase;
assigning a monetary value to the “gift” card; and
transferring a cash equivalent to the monetary value of the “gift” card to the investment product,
wherein transfer of the cash equivalent occurs upon redemption of the “gift” card.

10. The method according to claim 9, wherein the association of the “gift” card to an investment product allows for some measure of control by the gift giver.

11. The method according to claim 9, wherein the investment vehicle is at least one of a money market mutual fund, a stock mutual fund, a bond mutual fund, or an equity or income investment product.

12. The method according to claim 9, further comprising the step of:
placing the monetary funds collected at the point-of-sale in exchange for the “gift” card into a cash account.

13. The method according to claim 9, wherein the monetary denomination of the “gift” card is determined prior to the point-of-sale or at the time of purchase.

14. An apparatus for a mutual fund “gift” card, the apparatus comprising:
a mutual fund “gift” card issued by a card issuer;
an investment product offered by a financial institution, the product being associated with the mutual fund “gift” card; and
a means for transferring funds equivalent to a monetary value associated with the mutual fund “gift” card to the investment product;
wherein the funds are transferred upon redemption of the “gift” card to the investment product.

15. The apparatus according to claim 14, further comprising:
a means for tracking the monetary value of the “gift” card from association with the “gift” card through redemption of the “gift” card.

16. The apparatus according to claim 14, further comprising:
an account into which the funds equivalent to a monetary value associated with the mutual fund “gift” card are deposited.

17. The apparatus according to claim 16, wherein the account is held by one of the card issuer, the financial institution, a bank, and a broker.
